(19) United States
(12) Patent Application Publication
(10) Pub. No.: US 2017/0144230 A1
(43) Pub. Date: May 25, 2017

(54) TOOL CHANGING DEVICE

(71) Applicant: GIMATIC S.r.l., RONCADELLE (BS) (IT)

(72) Inventor: Guerino ROSSO, RONCADELLE (BS) (IT)

(73) Assignee: GIMATIC S.r.l., RONCADELLE (BS) (IT)

(21) Appl. No.: 15/353,156

(22) Filed: Nov. 16, 2016

(30) Foreign Application Priority Data
Nov. 24, 2015 (IT) 102015000076063

(51) Int. Cl. B23B 31/40; B25J 15/04

(52) U.S. Cl. CPC B23B 31/4046; B25J 15/0416; B25J 15/0425

(57) ABSTRACT

A tool changing device is described, which is provided with a male portion constrainable to a handler and a female portion constrainable to a tool to be handled and removably fittable on the male portion. Locking means are provided to lock the female portion on the male portion, and their respective actuator comprising an electric motor. The locking means are selectively movable between a locked position of the female portion and an unlocked position. Differently from conventional solutions, in the device according to the present invention advantageously the activation of the locking means is not assigned to the electric motor, on the contrary the latter has the task of only moving the locking means to the unlocked position; an elastic element is provided instead, which continuously applies a force holding the locking means in the locked position. The electric motor intervenes only to allow the female portion to be separated.

### FIELD OF THE INVENTION

The present invention relates to a tool changing device allowing the removable coupling of tools to a robotic manipulator.

### BACKGROUND

In the industrial automation field the use of tool changing devices allowing a robotized manipulator, for example an articulated arm, to take and handle on case-by-case basis the tool needed for a given machining is known.

Many solutions have been proposed, but the present invention relates particularly to the tool changing devices comprising:
a body, intended to be permanently fastened to the manipulator and provided with a male portion, and
a female portion, fastened to the tool to be taken and handled, the former being designed to receive and restrain the male portion for the necessary time.

In this typology of devices, members intended for reversibly blocking the male portion in the female portion are housed in the body. Traditionally, “tool quick changing devices” mean those tools changing devices in which the blocking members move at high speed for rapidly catching and releasing the male portion, for example in less than 1 second, and therefore the tool.

The operation can be of electric or pneumatic type, depending on whether the driving members are driven by an electric motor or else a pressurized fluid.

For example, the German company SCHUNK GmbH & Co KG produces a plurality of electrically or pneumatically operated tool changing devices. An electrically operated tool changing device is commercialized with the trade name ‘Electric Tool Changer EWS’, described in detail in the technical form available at the following Internet link:

http://www.schunk.com/schunk_files/attachments/OM_AU_EWS_EN.pdf.

Documents U.S. Pat. No. 8,132,816, U.S. Pat. No. 8,209,840, U.S. Pat. No. 8,747,288 and US 2012/0277080, in the name of ATI Industrial Automation, describe other examples of electrically operated tool changing devices.

WO 2007/106662, still in the name of ATI Industrial Automation, describes a pneumatically operated tool changing device, corresponding to the device shown in the instruction manual available at the following Internet link:

http://pdf.directindustry.com/pdf/ati-industrial-automation/robotic-tool-changers-standard-heavy-automation-series/24443-149717.html#open.

One of the most popular configurations is that in which the locking members are metal balls housed in the male portion and selectively movable between:
a locked position, at which the balls engage a corresponding seat or throat of the female portion, fitted on the male portion, in order to prevent the latter from slipping off, and
an idle position, at which the balls do not engage the male portion, therefore the latter not being restrained and separable from the male portion.

In practice, the balls are housed in appropriate seats in the male portion and are movable between a retracted position, i.e. the idle position, at which they do not protrude or they protrude only partially from the respective seats, and a protruding position, i.e. the locked position, at which they protrude from the respective seats just enough to engage the female portion and define a shape coupling therewith, similarly to an undercut.

As previously mentioned, the balls are displaced by using pneumatic or electric actuators.

The present invention concerns an electrically operated tool changing device.

The Applicant found that current electrically operated tool changing devices suffer from a significant drawback: the electric actuator must remain active—i.e. not in standby or idle mode—to hold the balls in the locked position and prevent the female portion from decoupling from the male portion. The accidental decoupling can indeed cause the tool to fall, the breakage of the handled pieces or even the wounding of persons operating nearby the manipulator.

In other words, the electric motor must be energized for all the time necessary to constrain the male portion in the female portion.

This aspect obliges the manufacturers to design and install complicated safety systems on the tool changing devices, typically of electronic type, for feedback controlling the state of the electric motor. Obviously influences on design, manufacture, setting up and maintenance costs of devices, in addition to put a strain on the weight thereof, are worth taking into account.

Other solutions known in the art provide, in addition to safety systems of electronic type, for the use of a retaining spring. In case of malfunction of the electric actuator, for example due to electric failure or black-out, the retaining spring prevents the accidental detachment of the tool since it is designed to apply onto the balls a weak force, anyway sufficient to prevent the balls from moving to the idle position.

When the spring intervenes to prevent the accidental detachment of the male portion, the coupling does not balance completely the electric actuator: the spring does not apply on the balls the thrust necessary to hold the balls in the protruding locked position, but only prevents the balls from moving to the idle retracted position. It follows that the male portion does not release itself from the female portion, but remains constrained thereto with great play. Anyway the tool is still unusable, hung but not operative.

In practice, in known solutions the retaining spring is redundant with respect to the safety systems of electronic type, but when alone it is not able to guarantee the effective coupling of the female portion on the male portion.

EP 1970170 describes a pneumatically operated tool changing device provided with a retaining spring.

Other solutions according to known art, provided with retaining spring, are also described in U.S. Pat. No. 4,636,135 and U.S. Pat. No. 6,398,279.

On the contrary it is desirable to simplify as much as possible the structure of the tool changing devices but, at the same time, to guarantee an efficient operation, without the possibility of accidental detachments of the female portion from the male portion, with the minimum electrical energy waste.

### SUMMARY

Object of the present invention is to provide a tool changing device solving the drawbacks of the conventional solutions, which is structurally simple, compact, quite lightweight, reliable and inexpensive.

Therefore, the present invention concerns a tool changing device according to claim 1.

In particular, the device comprises:
a main body constrainable to an external handling system, such as an industrial manipulator;
a male portion housed in the main body or made in one piece with the main body;
a female portion constrainable to a tool to be handled and removably fittable on the male portion;
locking means to lock the female portion on the male portion, and
an electric actuator of the locking means.

The locking means are selectively movable between a locked position, at which they engage the female portion when the latter is fitted on the male portion, thus preventing it from detaching from the male portion, and an unlocked position, at which they do not engage the female portion when the latter is fitted on the male portion, thus allowing its detachment.

Differently from the solutions according to known art, advantageously in the device according to the present invention the activation of the locking means is not assigned to the electric motor of the actuator, which has on the contrary the task of only moving the locking means to the unlocked position.

The actuator of the locking means comprises at least one elastic element, for example one or more springs, and just an electric motor. The elastic element continuously applies a force onto the locking means sufficient to move and hold them to the locked position, and the electric motor intervenes when necessary in order to counter such a force and move the locking means to the unlocked position.

In practice, the elastic element is calibrated to hold the locking means continuously locked; the electric motor intervenes only to unlock the male portion.

The suggested solution offers clear advantages. First of all, the electric motor is not necessarily kept active to hold the male portion coupled with the female portion; this task is in fact assigned to the elastic element performing it inherently with no electric energy consumption.

Therefore, the device structure can become particularly simple and light: no complex controlling systems for feedback controlling the electric motor have to be installed on board of the device. The elastic element guarantees the correct coupling of the male and female portions also in case of electrical black-out, i.e. in all cases the conventional devices could malfunction.

The electric motor is activated only to decouple the female portion from the male couple, to change the tool, contrary to what the known art provides.

The dependent claims specify the preferred aspects of the present invention.

In the preferred embodiment, the locking means comprise a plurality of balls, for example metal balls or made of a ceramic material, which are housed in corresponding seats obtained in the male portion, for example circumferentially on the respective outer surface. In the locked position the balls protrude at least partially from the respective seats just enough to engage a throat or corresponding niches obtained in the female portion, when the latter is fitted on the male portion. An undercut is thereby defined, which prevents the female portion from being slipped off just because the throat or the niches are restrained by the balls. On the contrary, in the unlocked position the balls, even if they are protruding from the male portion, do not engage the throat or the niches of the female portion, which can be therefore moved away from the male portion so that a tool change can be effected.

Preferably the male portion has a longitudinal axis and the balls are movable in the respective seats radially to said axis.

In the preferred embodiment the ball actuator further comprises a thrust element housed in the male portion and sliding between a forward position and a rearward position, respectively corresponding to the locking and unlocking of the locking means and, therefore, of the female portion. In line with the background idea of the present invention, the thrust element normally remains in the forward position due to the thrust applied by the elastic element and is moved to the rearward position by the electric motor, being constrained therewith, only to allow the detachment of the female portion, i. e. only for the time necessary to allow the detachment, with the afore described advantages.

Preferably the male portion is cylindrical or conical and the female portion comprises a hole having a shape complementary with the male portion thus being fittable on the latter, for example with minimum play.

In this embodiment, the thrust element defines a cylinder-piston coupling with the male portion. The housing seats of the balls are holes obtained through the side wall of the male portion; preferably the seats are shaped to prevent the balls from coming out completely and falling. For example, the seats are tapered so that only a portion of the balls could radially protrude to the outside of the respective seats. The thrust element in the respective forward position is contacting the portion of the balls facing the inside of the male portion: it is just the thrust element that applies on the balls, from the inside of the male portion, the thrust necessary to move them to the engagement with the female portion.

Preferably, the outer side surface of the thrust element, that is the surface facing the balls and the inner surface of the male portion, is tapered at least next to each ball. This feature allows to gradually thrust the balls when the thrust element moves from the rearward position to the forward position, in order to thrust the balls as much as possible until the locked position is reached.

In the preferred embodiment of the device according to the present invention, the elastic element is a spring, or a group of springs, which is/are interposed between the device body and the thrust element. Each spring is preloaded and calibrated to continuously apply such a thrust on the thrust element to move it to its forward position, guided by the inner surface of the male portion.

Preferably the coupling between the electric motor and the thrust element is obtained by means of a kinematic system, a cam, a coupling or joint both eccentric, i.e. which are acting on an axis parallel to the axis on which the electric motor operates. If necessary, at least one groove can be provided on the cam or kinematic system/coupling/joint, at a stable position of the thrust element, for example at the relative forward position.

For example, the electric motor can be a motor whose shaft is connected with an eccentric cam to the thrust element; the axis of the shaft of the electric motor is orthogonal to the longitudinal axis of the male portion.

The device can comprise switches—for example microswitches—, or encoders or a circuit detecting the current demand of the power device, which are used to automatically switched off the electric motor, and keep it switched off, until the detachment of the female portion is required.

In a second embodiment of the device the elastic element is a spring, or a group of springs, which is/are interposed between the thrust element and a cursor sliding in the device body parallel to the axis of the male portion. Each spring is preloaded and calibrated to continuously apply such a thrust on the thrust element to move it to its forward position, guided by the inner surface of the male portion.

In this second embodiment, the electric motor intervenes to modify the vertical cursor position, i.e. the height the cursor takes in the device body at a given moment, to cause the displacement of the thrust element. Therefore, differently from the first embodiment described above, the electric motor does not act directly on the thrust element but it acts on the cursor that, in turn, cooperates with the spring/s in order to give the vertical displacements to the thrust element, parallel to the axis of the male portion.

### BRIEF DESCRIPTION OF THE DRAWINGS

Further characteristics and advantages of the invention will be more evident by the review of the following specification of a preferred, but not exclusive, embodiment, depicted for illustration purposes only and without limitation, with the aid of the attached drawings, in which:

FIG. 1 is a perspective view of a first embodiment of the tool changing device according to the present invention, in a configuration with the female portion separated from the male portion;

FIG. 2 is a perspective view of the device shown in FIG. 1, in a configuration with the female portion coupled to the male portion;

FIG. 3 is a perspective view of the device shown in FIG. 1, in the same configuration, but equipped with electrical connections;

FIG. 4 is a perspective view of the device shown in FIG. 1, in a configuration with the female portion coupled to the male portion and equipped with electrical connections;

FIG. 5 is an exploded view of the device shown in FIG. 1, without the female portion;

FIG. 6 is a vertical sectional view of the device shown in FIG. 1;

FIG. 7 is a vertical sectional view of the device shown in FIG. 1;

FIG. 8 is an exploded view of a second embodiment of the device of the present invention;

FIG. 9 is a vertical sectional and perspective view of the assembled device shown in FIG. 8, in a first configuration;

FIG. 10 is a vertical sectional and perspective view of the assembled device shown in FIG. 8, in a second configuration;

FIG. 11 is a vertical sectional and elevation view of the assembled device shown in FIG. 8, in a first configuration; and

FIG. 12 is a vertical sectional and perspective view of the assembled device shown in FIG. 8, in a second configuration.

### DETAILED DESCRIPTION OF THE PREFERRED EMBODIMENTS

FIG. 1 is a top perspective view of a device 1 according to the present invention, comprising a box-shaped body 2. On the body 2 a plate 3 is installed and includes a male portion 4 that, in the embodiment shown in the figures, is constituted by a conical portion 4 cantileverly extending from the body 2. The device 1 further comprises a female portion 5 removably couplable to the male portion 4.

In particular, the female portion 5 has a central hole 6 having a shape complementary to the male portion 4, so that the male portion 4 can be inserted in the female portion 5 with minimum play.

The body 2, and the male portion 4 therewith, can be both fastened to a manipulator, for example a robotic arm or a numerical control machine, and the female portion 5 can be fastened to a tool or piece to be handled.

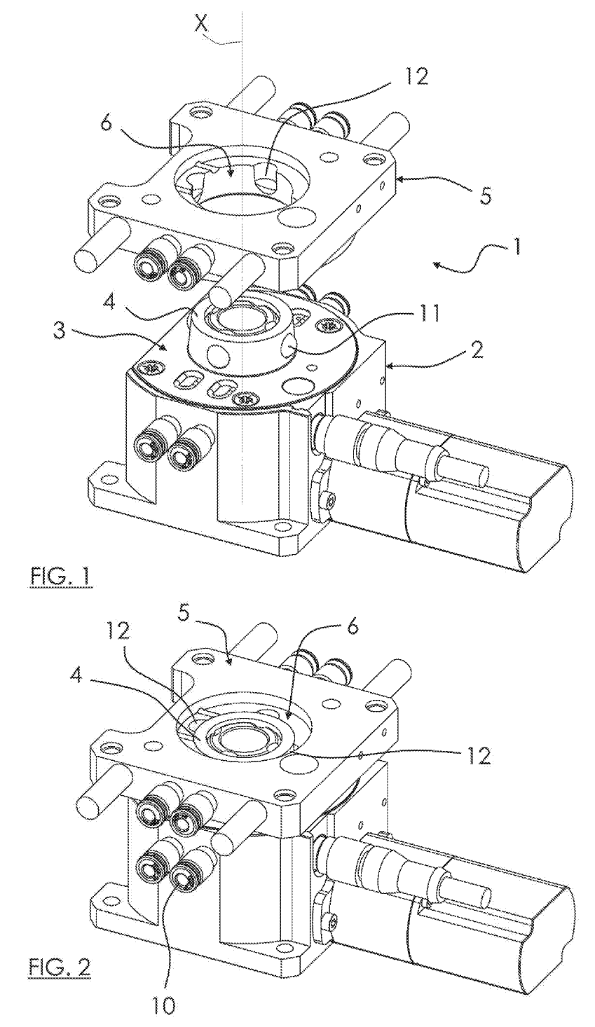

FIG. 2 shows the female portion 5 fitted and locked on the male portion 4. The conical portion 4 is inserted in the hole 6.

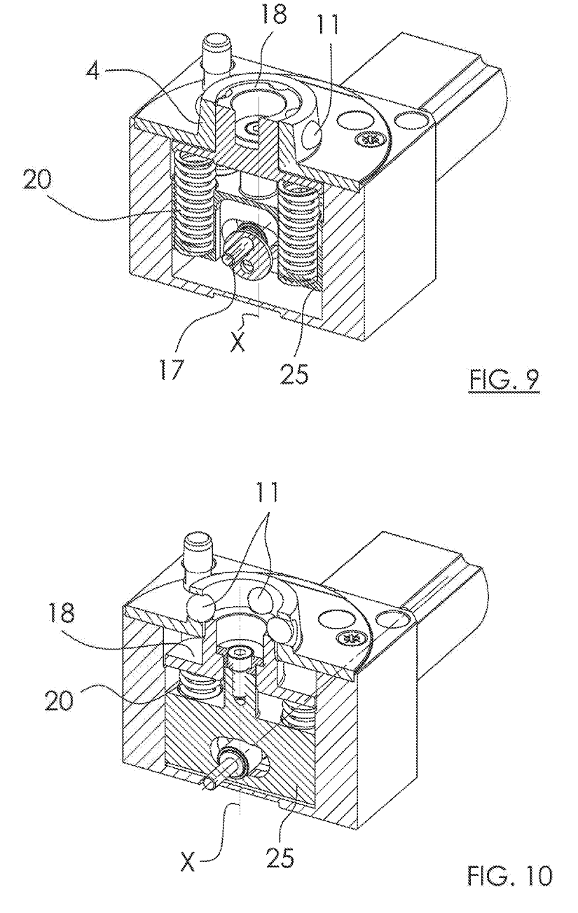

Referring to FIG. 10, connectors for pressurized fluids are depicted.

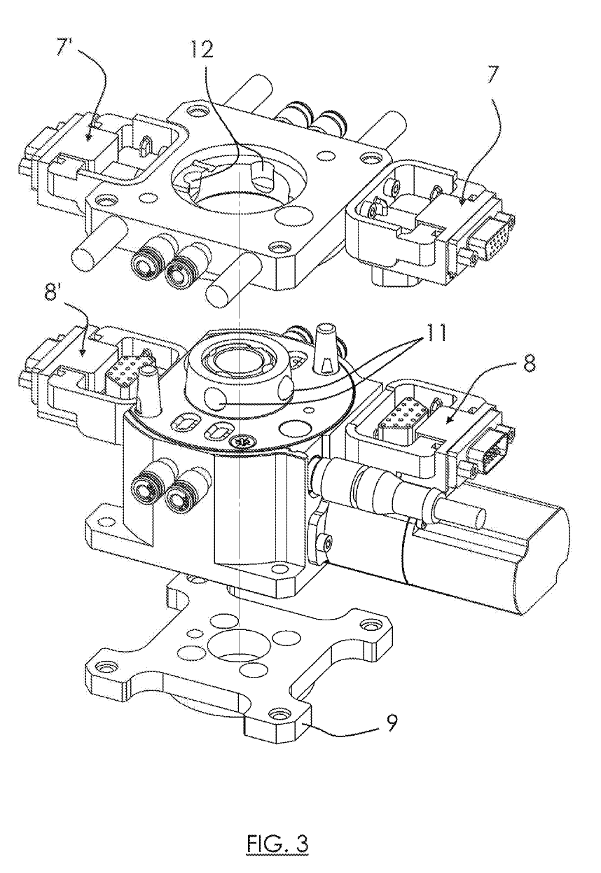

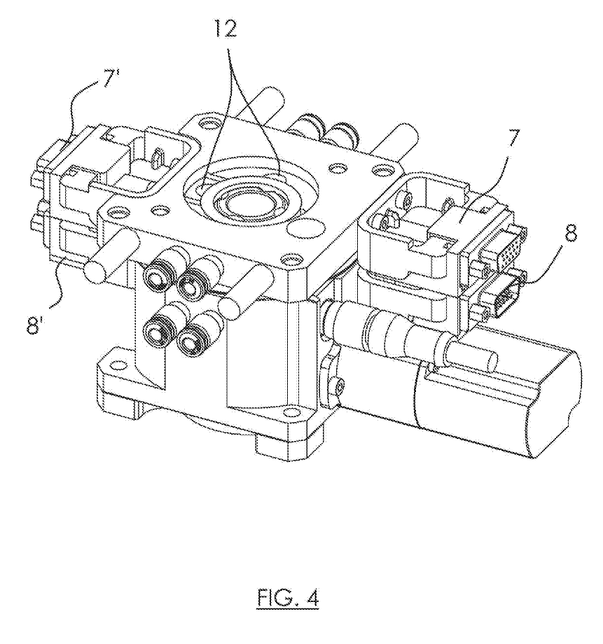

FIGS. 3 and 4 correspond to FIGS. 1 and 2, the difference being that the device 1 is shown as provided with electrical connectors 7, 7′ and 8, 8′ and with a fastening bracket 9 to fasten the body 2 to a manipulator.

As can be seen in FIGS. 1 and 3, there is a plurality of balls on the conical part 4 of the male portion 4, which are arranged circumferentially at even pitch at the same height. The balls 11 are housed in appropriate seats obtained in the wall of the conical part 4.

The balls 11 are designed as locking means to lock the female portion 5 on the male portion 4. As a matter of fact the balls 11 are movable, selectively and by command, between an unlocked position radially nearer to the vertical symmetry axis X of the conical part 4, and a locked position radially farther from such axis X.

At the hole 6 of the female portion 5 a throat is obtained, or better a plurality of niches or grooves 12 in which a ball 11 can be inserted at least in part when it is in the locked position. The niches 12 are tapered so that to define an undercut with the balls 11 and to prevent the female portion 5 from detaching from the male portion 4. FIGS. 2 and 4 just show the female portion 5 locked on the male portion 4, with the balls 11 meshed in the niches 12. The female portion 5 can be separated only by moving the balls 11 to the unlocked position; hereinafter it will be explained how the balls 11 are handled.

In the example shown in the figures, the device 1 comprises four balls 11 and as many niches 12.

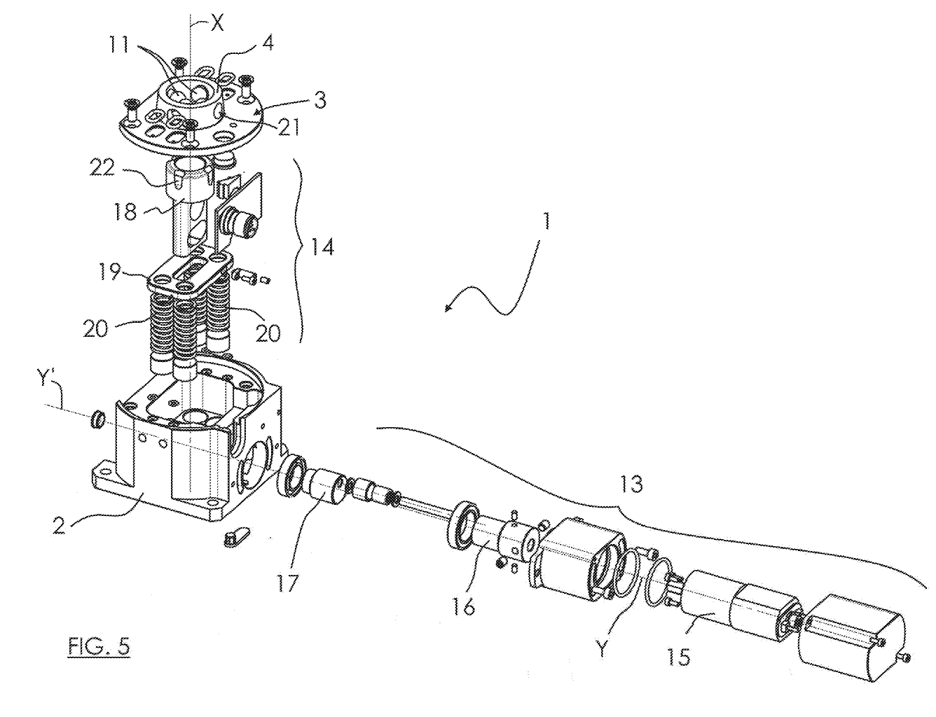

FIG. 5 is an exploded view of the device 1. With the numeral reference 13 an electric power device is generically depicted, which comprises an electric motor 15 whose shaft 16 extends and rotates on an axis Y orthogonal to the axis X. With the numeral reference 17 a cam eccentrically connected to the shaft 16 of the electric motor 15 is depicted, so that to define a second axis Y′ parallel to the axis Y.

With the numeral reference 14 is generically depicted an assembly comprising an element 18 intended to give a thrust to the balls 11 from the inside of the conical portion 4, a supporting plate 19 to support the thrust element 18 and a pack of vertically arranged helical springs 20, i.e. which are parallel to the axis X.

As can be noted, four through-holes 21 are obtained through the side wall of the conical part 4 of the male portion. The through-holes 21 constitute the housing seat of the balls 11 and are shaped to prevent the balls 11 from excessively protruding to the outside and thus falling; in other words, the balls 11 have to be movable in the holes 21 but anyway they must not come out outwards. In FIG. 7 it is possible to appreciate that the holes 21 are not circular but conical, just to prevent the undesirable fall of the balls 11 outwards.

The thrust element 18 has a shape substantially complementary to the conical portion 4 in order to slide alternately in inside thereof, as a piston would do in the respective cylinder. The radial displacement of the balls 11 in the holes 21, in the two ways, is just controlled by the alternate vertical movement of the thrust element 18.

When the thrust element 18 moves to the completely raised position corresponding to the top dead center if referred to the piston in cylinder similarity, the balls 11 are thrust as must as possible into the holes 21 until the locked position is reached, i.e. until a part of the balls 11 protrudes outside of the holes 21 to engage the female portion (not shown in FIG. 5 for simplicity).

When the thrust element 18 moves to the completely lowered position, i.e. to the inside of the body 2 corresponding to the bottom dead center if referred to the piston in cylinder similarity, the balls 11 are free to come back into the holes 21 until the unlocked position is reached.

On the outer surface of the thrust element 18 four tapers 22 are obtained acting as guide ramps of the balls 11: when the thrust element 18 moves to the completely raised position, the tapers 22 gradually thrust the balls 11 to the locked position and when the thrust element 18 moves to the completely lowered position, the tapers 22 act as limits preventing the balls from falling inside the male portion 4.

When the device 1 is assembled the springs 20 are compressed, i.e. preloaded, and continuously apply a thrust onto the supporting plate 19, which in turn tends to hold the thrust element 18 steadily in the raised position. Therefore, the springs 20 operate to hold the balls 11 continuously in the locked position of the female portion 5.

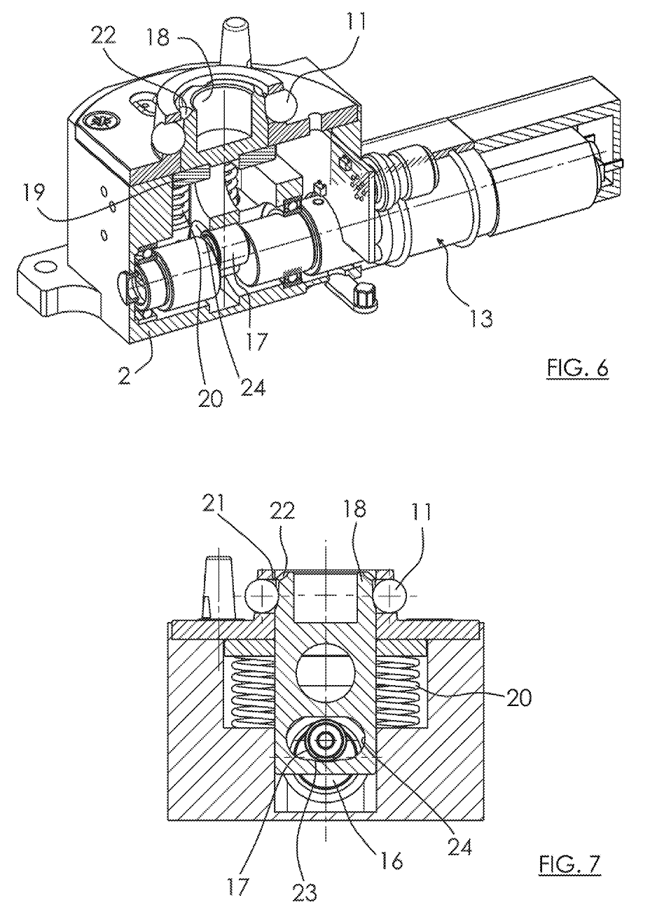

FIGS. 6 and 7 show this concept in the best way. In particular, in these figures the device 1 is shown with the balls 11 in the locked position, i.e. they are thrust to the limit radially to the outside of the respective holes 21 by the thrust element 18 completely raised by the force the springs 20 apply.

In order to achieve the detachment of the female portion 5, the electric motor 15 is necessarily activated to rotate the respective shaft 16 by half revolution and, through the cam 17, to thrust downwards the thrust element 18, thus releasing the balls 11 which can partially come back into the holes 21 for the disengagement of the niches 12 visible in FIG. 1. The unlocked position is not shown in the attached figures.

The cam 17 dwells in a slot 24 obtained in the thrust element 18 and visible in FIGS. 5, 6, and 7. The inner surface of the slot 24 is locally machined to obtain a slight groove depicted with the numeral reference 23. The groove 23, which is just a little hollow, is for defining a stable equilibrium position of the cam 17. Since the cam 17 is assembled eccentrically with respect to the shaft 16 of the electric motor, the presence of the groove 23 is useful for holding the cam 17 in a stable position when the motor is not active.

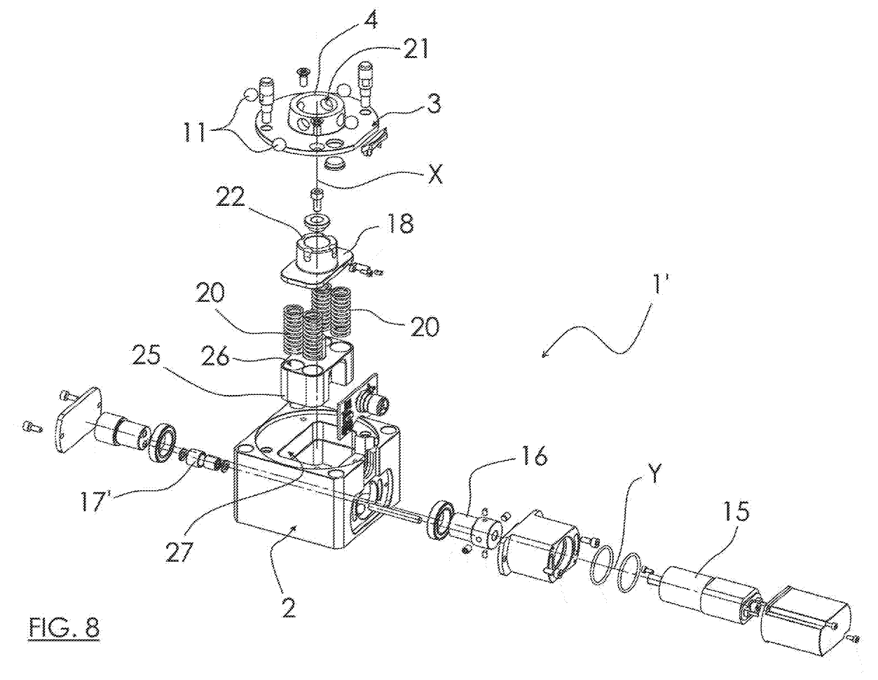

The FIG. 8 shows a second embodiment 1′ different from the first one 1 in that it comprises a cursor 25 housed in an appropriate seat 27 obtained in the body 2. The cursor 25 slides in the seat 27 in parallel to the axis X, which is the longitudinal axis of the male portion 4. The vertical movements of the cursor 25 in its seat 27 are controlled by the power device 15, also in this example an electric motor, through a cam mechanism 17′ equivalent to the above described one.

The cursor 25 comprises a seat 26 per each spring 20, four in the shown example, which are socket-shaped. In the assembling step the springs 20 are inserted in the seats 26 of the cursor 25 and press onto the thrust element 18 on top.

FIGS. 9 and 10 aid the comprehension of the operation of the device 1′. They are vertical sectional views, respectively on a plane not containing the axis X and on a plane containing the axis X, but anyway orthogonal to the axis Y of the electric motor 15.

In particular, in FIG. 9 the device 1′ is shown in the locked position of the balls 11 and in FIG. 10 it is shown in the unlocked position. In FIG. 9 the thrust element 18 is completely raised since the cam 17′ holds the cursor 25 in the maximum height position in the seat 27. Therefore, the cursor 25 is raised to the male portion 4 and the springs 20 hold the thrust element 18 pressed against the male portion 4, in a forward position corresponding to the blocking of the balls 11. In FIG. 10 the thrust element 18 is lowered since the cam 17′ holds the cursor 25 in the minimum height position in the seat 27, almost at the bottom. Therefore, the cursor 25 is lowered towards the bottom of the seat 27, and the springs 20, although extended, are not able to hold the thrust element 18 in the forward position and pressed against the male portion 4; on the contrary, the thrust element 18 is in the retracted position, the balls 11 being free to come back into the respective seats 21 to unlock the female portion.

FIG. 11 clearly shows the device 1′ in the locked position, with the balls 11 thrust to the outside by the thrust element 18. In this figure it can be appreciated that the travel D, become available for the cursor 25, is greater than or equal to the length difference between the compressed and extended springs 20, as shown respectively in FIGS. 9 and 10. The travel D must be indeed sufficient to allow the cursor 25 to move the thrust element 18 to a retracted position, although the springs can extend or return to the initial not-preloaded length.

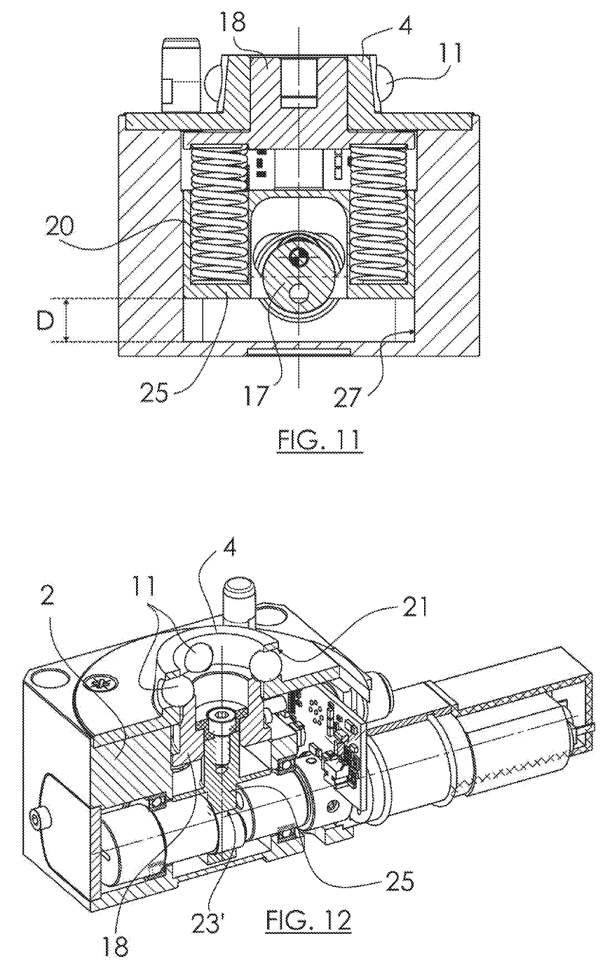

FIG. 12 shows a vertical section taken on a plane containing the axis Y of the shaft of the electric motor 15. In this figure it can be seen that the cursor 25 is provided with at least one groove 23′ at which the cam 17′ is in stable equilibrium, corresponding to the device 1′ in locked position.

1. A tool changing device (1) comprising:
a main body (2) constrainable to an external handling system;
a male portion (4) housed in the main body (2);
a female portion (5) constrainable to a tool to be handled and removably fittable on the male portion (4);
locking means (11) to lock the female portion (5) on the male portion (4), and
an actuator (13, 14) of the locking means (11),
wherein the locking means (11) are selectively movable between a locked position, at which they engage the female portion (5) fitted on the male portion (4) and prevent it from detaching from the male portion (4), and an unlocked position at which they do not engage the female portion (5) and allow it detaching from the male portion (4),
wherein the actuator (13, 14) of the locking means comprises at least one elastic element (20) and an electric motor, and in that the elastic element (20) continuously applies a force onto the locking means (11) sufficient to move and hold them to the locked position, and the electric motor (15) intervenes when necessary in order to counter such a force and move the locking means (11) to the unlocked position.

2. The device (1) according to claim 1, wherein the locking means (11) comprise a plurality of balls (11) housed in corresponding seats (21) obtained in the male portion (4), and wherein the balls (11) in the locked position protrude at least partially from the respective seats (21) and engage a throat or corresponding niches (12) obtained in the female portion (5), fitted on the male portion (4), therefore realizing an undercut, and in the unlocked position the balls (11) do not engage said throat or said niches (12) of the female portion (5).

3. The device (1) according to claim 2, wherein the male portion (4) has a longitudinal axis (X) and the balls (11) are radially movable with respect to said axis (X).

4. The device (1) according to claim 2, wherein the ball actuator further comprises a thrust element (18) housed at least in part in the male portion (4) and sliding between a forward position, at which it forces the locking means (11) into the locked position, and a rearward position, at which the locking means (11) are in the unlocked position, and wherein the thrust element (18) normally remains in the forward position due to the thrust applied by the elastic element (20) and is moved to the rearward position by the electric motor (15), being constrained therewith, only to allow the detachment of the female portion (5).

5. The device (1) according to claim 4, wherein the male portion (4) is cylindrical or conical and the female portion (5) comprises a hole (6) having a shape complementary with the male portion (4) thus being fittable thereon.

6. The device (1) according to claim 5, wherein the thrust element (18) defines a cylinder-piston coupling with the male portion (4), and wherein the housing seats (21) for the balls (11) are holes obtained through the side wall of the male portion (4), and wherein the thrust element (18) in the respective forward position is contacting the portion of the balls (11) facing the inside of the male portion (4).

7. The device (1) according to claim 6, wherein the outer side surface of the thrust element (18), that is the surface facing the balls (11) and the inner surface of the male portion (4), is tapered (22) at least next to each ball (11) so that to gradually thrust the balls (11) into the respective seats (21) while moving from the rearward position to the forward position, in order to make the balls (11) protrude outside until they reach the locked position.

8. The device (1) according to claim 4, wherein the at least one elastic element (20) is at least one spring interposed between the body (2) of the device and the thrust element (18), said at least one spring (20) being preloaded to continuously apply a thrust to the thrust element (18) to the forward position thereof.

9. The device (1) according to claim 4, wherein the thrust element (18) is operatively coupled with the electric motor (15) by means of an eccentric kinematic system (17).

10. The device (1) according to claim 9, wherein the electric motor (15) is a motor whose shaft (16) is connected with an eccentric cam (17), or a coupling or joint both eccentric, to the thrust element (18), where the axis (Y) of the shaft (16) of the electric motor (15) is orthogonal to the longitudinal axis (X) of the male portion (4).

11. The device (1) according to claim 10, wherein the thrust element (18) comprises at least one groove (23) at which the eccentric cam (17) is in a stable equilibrium position.

12. The device (1′) according to claim 1, further comprising a cursor (25) sliding in a respective seat (27) in the body (2), between a proximal position and a distal position with respect to the male portion (4), and wherein the at least one elastic element (20) is at least one spring interposed between the cursor (25) and the thrust element (18), said at least one spring (20) being preloaded to continuously apply a thrust to the thrust element (18) to the forward position thereof.

13. The device (1) according to claim 12, wherein the cursor (25) is operatively coupled with the electric motor (15) by means of an eccentric kinematic system (17′).

14. The device (1) according to claim 13, wherein the electric motor (15) is a motor whose shaft (16) is connected with an eccentric cam (17′), or a coupling or joint both eccentric, to the cursor (25), where the axis (Y) of the shaft (16) of the electric motor (15) is orthogonal to the longitudinal axis (X) of the male portion (4).

15. The device (1) according to claim 14, wherein the cursor (25) comprises at least one groove (23′) at which the eccentric cam (17′) is in a stable equilibrium position and the cursor is proximal to the male portion (4).
